(19) United States
(12) Patent Application Publication
(10) Pub. No.: US 2020/0306905 A1
(43) Pub. Date: Oct. 1, 2020

(54) Method of Controlling Transport Vehicles for Transporting Sliver Cans in a Spinning Mill and a Transport Vehicle for Performing the Method

(71) Applicant: Maschinenfabrik Rieter AG, Winterthur (CH)

(72) Inventors: Jiri Sloupensky, Sloupnice (CZ); Josef Cernohorsky, Pencin (CZ); Miroslav Novak, Liberec (CZ)

(21) Appl. No.: 16/832,876

(22) Filed: Mar. 27, 2020

(30) Foreign Application Priority Data
Mar. 28, 2019 (CZ) PV2019-191

(51) Int. Cl. B23Q 11/00

(52) U.S. Cl. CPC B23Q 11/0042; B65G 3/04

(57) ABSTRACT

The invention relates to method of controlling a transport vehicle for transporting exactly one sliver can (2) in a spinning mill between a filling station (3) for depositing a sliver into cans (2) and working positions of the cans (2) at workstations of the spinning machines (4), which ensures supplying the spinning machines with full cans (2) with a sliver. A request for can (2) replacement at the respective workstation of the spinning machine (4) is generated on the basis of the information from the spinning machines (4) about the remaining quantity of the sliver in the cans (2) at the individual workstations of the spinning machines (4), or information about the removal of the can (2) by the operator during spinning, the information being passed to the control system (5) of the spinning mill, which on the basis of this request predicts the moment of the conveying of the can (2) by the transport vehicle (1) to the respective workstation and the request is placed into a request queue which is optimized for the maximum utilization of the spinning machines (4) with respect to the current position and working activity of the transport vehicles (1), whereby in order to control the individual transport vehicles (1), data/information from the localization system, as well as data/information from the transport vehicle (1), is evaluated and processed.

The invention also relates to a transport vehicle for performing the above described method.

### TECHNICAL FIELD

The invention relates to a method of controlling transport vehicles for transporting sliver cans in a spinning mill between a filling station for filling cans with a sliver and working positions of the cans at workstations of spinning machines, which ensures supplying sliver cans for the spinning machines.

Furthermore, the invention relates to a transport vehicle for carrying out the above method.

### BACKGROUND ART

The automation of the operation of a spinning mill is an important means of eliminating secondary working time which is mainly related to the handling and transport of a sliver between a preparatory spinning machine producing it and a spinning machine for which the sliver is an input semi-finished material to be processed.

Increasing the productivity of the spinning machines is directly related to the requirement for an increased volume of a sliver to be transported in sliver cans in a spinning mill. To transport them, transport belt conveyors or separate transport trolleys are used. The movement of these means of transport is usually automated and organized by a control unit of the spinning mill according to the requirements and possibilities of the coupled preparatory spinning machines and spinning machines.

In this process, the originally cylindrical cans were switched to non-circular cans, usually in the form of a rounded cuboid, the width of which is based on the spatial possibilities of the individual workstations of the spinning machine, which are arranged in large numbers along the length of the long spinning machines. In terms of time savings, it was essential to increase the number of sliver cans that the means of transport was able to carry at a time.

Such a means of transport can now carry, for example, eight cans and, in a single circuit, can serve several workstations of the spinning machine to which it delivers full cans and returns to the preparatory spinning machine with empty cans. The spinning mill can have several such means of transport.

A typical arrangement of a spinning mill of this type and the method of moving cans between at least one preparatory spinning machine producing a sliver and at least one spinning machine that processes the sliver is described in EP877107B2. The spinning mill is provided with a track which is arranged in such a manner that it allows motor driven transfer of a row of known cans, in the exemplary embodiment non-circular cans rectangular in plan, between these machines. In the exemplary embodiment shown, five cans are placed in a common rack that is loaded on a wagon. The number of wagons and can racks is determined by the size of the spinning mill, that is, the number of sliver manufacturing machines and the number of spinning machines. Arranged in the spinning mill is also a depot where cans, both empty and full, are temporarily stored.

In a preferred embodiment shown, between the machines and the depot a circular track is arranged for the motor driven movement of the wagons, which may be realized, for example, as an induction line in the spinning mill floor or an ultrasonic or infrared guidance system, disposed along the workstations of the spinning machine, along a temporary can depot and along filling area for filling the cans with sliver, the filling area being associated with the preparatory spinning machine. The wagon with a rack in which there are empty cans stops in the vicinity of the can filling area, whereupon the can rack is moved from the wagon to the first waiting station of a slide conveyor of the filling area. The can rack is moved by the slide conveyor from the first waiting station to the filling area in which the cans are subsequently filled with sliver and the rack with full cans is moved to the second waiting station. In the meantime, the emptied wagon is moved to the second waiting station to which is transferred the rack with filled cans which is then along the circular track moved to empty workstations of the spinning machine to which the full cans are transferred. Unused full cans and loaded empty cans are transported and, if appropriate, placed in a temporary can depot. On the slide conveyor of the preparatory spinning machine, three can racks can be placed at the same time in a row, which increases the filling speed and hence the spinning mill production. The entire operation of can manipulation is controlled by the central control unit which is connected to the preparatory spinning machine, the spinning machine, the temporary depot and the wagons.

DE 3621370 discloses a device for conveying at least one can between a sliver-producing spinning machine, for example a carding machine, and a spinning machine processing a sliver, such as a drawing machine, by means of a transport trolley on which a can loading device and a can unloading device are arranged, whereby the loading and unloading devices have conveyor elements for moving the can with respect to the transport trolley. In a basic embodiment, the can is loaded onto a platform of the trolley, in an alternative embodiment, the can is equipped with wheels on which it runs on the floor of the spinning mill. The trolley is designed for heavy and bulky cylindrical cans and its can handling means keep the can from the side against each other so that it increases their width and therefore they are not suitable for handling cans for spinning machines which are arranged below the spinning machines with very small distances between them, whether the cans are cylindrical or non-circular. Cylindrical cans are usually arranged at the workstations of the spinning machines in two rows one after the other.

DE4324105 describes a solution in which a lid is provided on a full can to handle the full can during replacement. However, the device is very complicated, includes a turntable for turning the cans into a replacement position and the movement of the carriage is only movable on a rail, which brings additional costs on the equipment of the spinning mill.

CZ280704 discloses a transport carriage for several non-circular cans which are arranged on the carriage with their longitudinal axes running perpendicular to the direction of the carriage movement. On the carriage, there is one free space for a can, into which, during the can replacement at the workstation of the spinning machine, an empty can is transferred by the means of the carriage and then a full can from the carriage is moved to the vacant space below the spinning machine. The carriageway is determined by an induction loop built into the floor of the spinning mill. The disadvantages of this solution include the problem of large dimensions of the carriage, which require a relatively large handling space between the machines and the fact that the non-circular watering cans have not yet found such a wide application in the spinning industry as expected. For classical circular cans this method of manipulation does not seem economical, therefore no technical solution in this area is known yet.

The object of the invention is therefore to provide an economically advantageous and technically simple method for controlling a transport vehicle for transporting exactly one cylindrical sliver can with flexible navigation in order to supply the spinning machines with a sliver produced on preparatory machines without the need to install a separate track and without reconstruction of the spinning mill floor.

It is a further object of the invention to provide a transport vehicle for performing this method.

### PRINCIPLE OF THE INVENTION

The object of the invention is achieved by a method of controlling transport vehicles in a spinning mill, whose principle consists in that the request to replace a can at the relevant workstation of a spinning machine is based on the information from the spinning machines about the remaining quantity of the sliver in the cans at the individual workstations of the spinning machines, or on the information about the removal of the can by the operator during spinning, wherein the can replacement request is passed to the control system of the spinning mill, which on the basis of this request predicts the moment of the conveying of the can to the workstation by the transport vehicle and stores it in a queue of requests, which is optimized by the control system of the spinning mill with respect to the current position and working activities of the individual transport vehicle, whereby information from the spinning localization system of the spinning mill and information from the control unit of the transport vehicle is processed by the control system of the spinning mill to control each transport vehicle. The advantage of this system is a considerable increase in the flexibility of the control of individual transport vehicle movement which leads to achieving higher efficiency in changing the range of processed range of goods, which usually requires, for example, an increased number of transport vehicles when switching to a coarser yarn number of the processed yarn. Also, when changing the spinning mill configuration (e.g., when installing additional new machines), the method of controlling the transport vehicle can be adapted very easily to comply with the new requirements to the greatest extent possible.

A particular embodiment of the localization system of the spinning mill according to the invention comprises a plurality of stationary navigation points/anchors of a known position relative to the spinning mill infrastructure, wherein each transport vehicle is provided with a transponder for communicating with the navigation points/anchors to monitor the position, direction and speed of the transport vehicle relative to the spinning mill infrastructure, whereby the information about the speed, direction, and position of the transport vehicle is transmitted to the control system of the spinning mill and based thereon, commands for driving and other operations of the transport vehicle are generated in the control system of the spinning mill. Thus, the transport vehicle, either empty or with exactly one can, is able to move on the floor of the spinning mill only on the basis of the information from the localization system according to the previous paragraph and on the basis of direct wireless communication with the control system of the spinning mill, whereby the can which also moves on the floor of the spinning mill, and no modifications to the floor of the spinning mill are needed with respect to the transport vehicle or the can.

In this connection, it is advantageous if the information about the remaining quantity of the sliver in the cans by the individual workstations of the spinning machines is generated in the control system of the spinning mill on the basis of the knowledge about the quantity of the sliver filled into each can at the filling station, which is stored individually for each can in the memory of the control system of the spinning mill, and at the moment of placing the can in the working position at the workstation of the spinning machine, information about the quantity of the sliver in this can is passed to the control system of the respective spinning machine, which on the basis of this information monitors the quantity of the processed sliver for each workstation from the moment of can replacement and generates and maintains information about the remaining quantity of the sliver in the can, which is passed to the control system of the spinning mill.

The quantity of the sliver being processed is monitored at the workstation according to the quantity/length of the spun yarn and/or the distance travelled by the sliver feeding roller. Based on this information, the control system of the spinning mill creates a predictive queue of requests for empty cans replacement. This queue is then used to plan efficient movement of the transport vehicles.

In a preferred embodiment, the information about the remaining quantity of the sliver in the can is generated in the control system of the spinning machine at each natural yarn break by comparing the quantity/weight of the sliver originally deposited in the watering can with the quantity/weight of the spun yarn and if the difference between these values is within a predetermined interval close to zero, a request for priority can replacement at the respective workstation is generated, which is transmitted to the control system of the spinning mill.

If the can is completely or almost completely empty, or if the can has been removed by the operator, a priority can replacement request is made in the control system of the spinning machine, which, in the control system of the spinning mill, is placed into the queue of requests for can replacement of the workstations to a priority position. This will speed up the exchange for a full can.

The principle of the control of the transport vehicle for performing the above described method consists in that the transport vehicle is provided with a communication unit with a transponder for communication between the control system of the spinning mill, which is also coupled to a transponder for the communication with the localization system of the spinning mill, and is also coupled to the localization system of the spinning mill and the control unit of the transport vehicle.

For accurate guidance of the transport vehicles, it is advantageous if the localization system of the spinning mill comprises a plurality of stationary navigation points/anchors of known position relative to the infrastructure of the spinning mill, whereby the navigation points/anchors and the control system of the spinning mill are interconnected/interconnectable.

The advantage of this solution is a considerable flexibility of the whole system. Stationary navigation points/anchors can be freely moved when the configuration of the spinning mill is changed, and their new position is recorded in the memory of the control system of the spinning mill.

In order to ensure the safety of the operator moving in the area of the spinning mill, a virtual approach area is formed around the transport vehicles and a near surroundings area is formed within this virtual approach area. If there is an obstacle in the approach area, the speed of the transport vehicle decreases, if the obstacle occurs in the area of the near surroundings, the transport vehicle stops.

In order to keep the transport vehicle in the intended path, the control unit of the transport vehicle, based on the instructions of the control unit of the spinning mill, individually controls the operation of the drive wheels of the vehicle for their travel over a specified distance and their angular orientation.

Furthermore, on the basis of the instructions of the control system of the spinning mill, the control unit of the transport vehicle controls individually the operation of the motor of the left drive wheel and the motor of the right drive wheel, monitoring the magnitude of the current supplied to them, and any unexpected drop in the current magnitude is evaluated by the control unit of the transport vehicle as a slip in the respective drive wheel and this information is transmitted to the control system of the spinning mill to tune the guidance of the transport vehicle.

In order to prevent the vehicle battery from being completely discharged, its control unit also monitors the battery cell voltage and, when the set voltage limit is reached, it generates a drive request to the charging station and sends it to the control system of the spinning mill.

### DESCRIPTION OF THE DRAWINGS

The invention will be described in more detail in the enclosed drawings, where:

FIG. 1 shows a scheme of the system of a spinning mill,

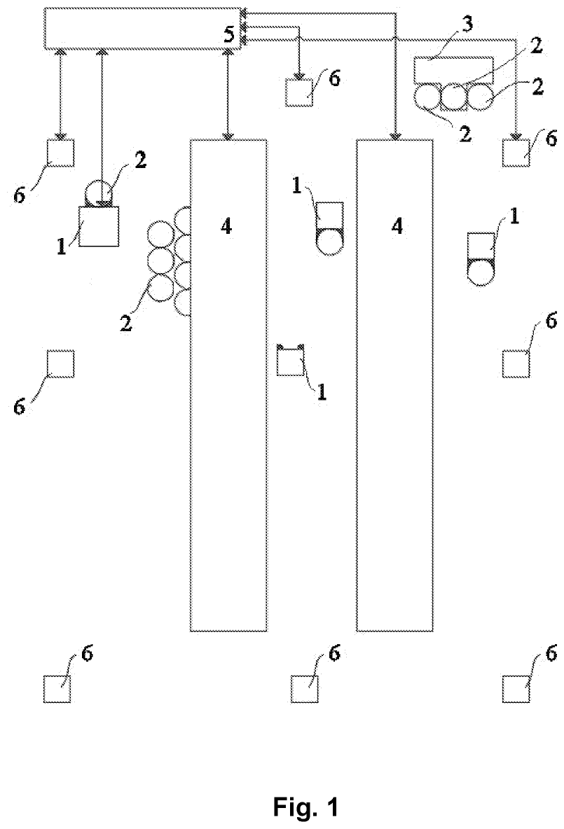

FIG. 2a shows a diagram of the vehicle and the virtual areas around it, and

FIG. 2b shows a view of the transport vehicle with an indicated can being transported.

### EXAMPLES OF EMBODIMENT OF THE INVENTION

The method of controlling transport vehicles 1 for transporting sliver cans 2 in a spinning mill between a filling station 3 for filling sliver into cans 2 and working positions of cans 2 at workstations of spinning machines 4 will be described with reference to an exemplary embodiment of a spinning mill comprising at least one filling station 3, in which a sliver is deposited in sliver cans 2 in a known manner. The filling station 3 is connected to one or more preparatory machines, for example carding, combing or drawing machines, and a storage device of empty cans 2 and a storage device of full cans 2. Each can 2 in the spinning mill is assigned a unique identifier. When filling the can 2 with a sliver, the quantity of the sliver deposited into the can 2 is monitored and, after completion of filling, each filled can 2 on the basis of its identifier is assigned individual information about the length/quantity of the sliver deposited in the can 2 and this information for the respective can is stored in the memory of the control system 5 of the spinning mill.

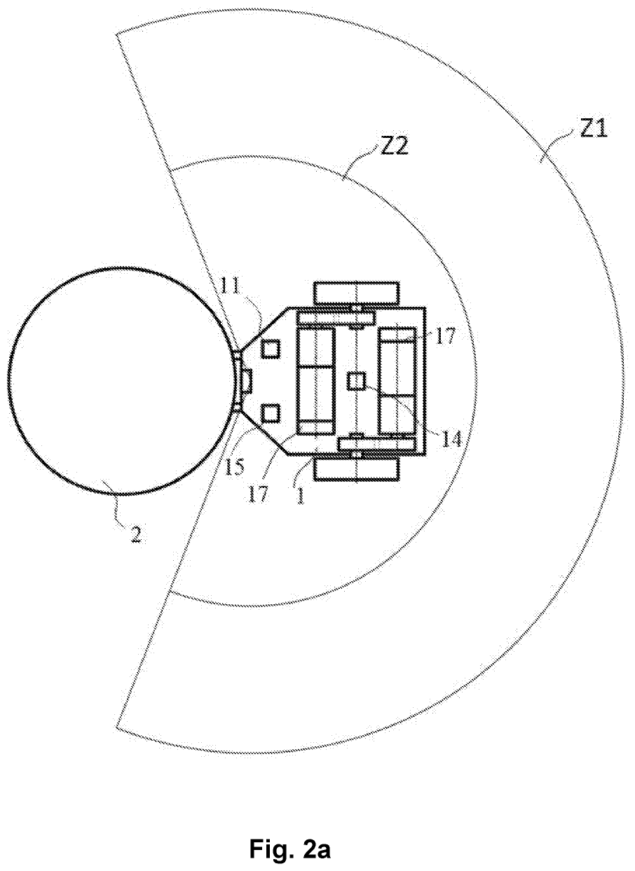

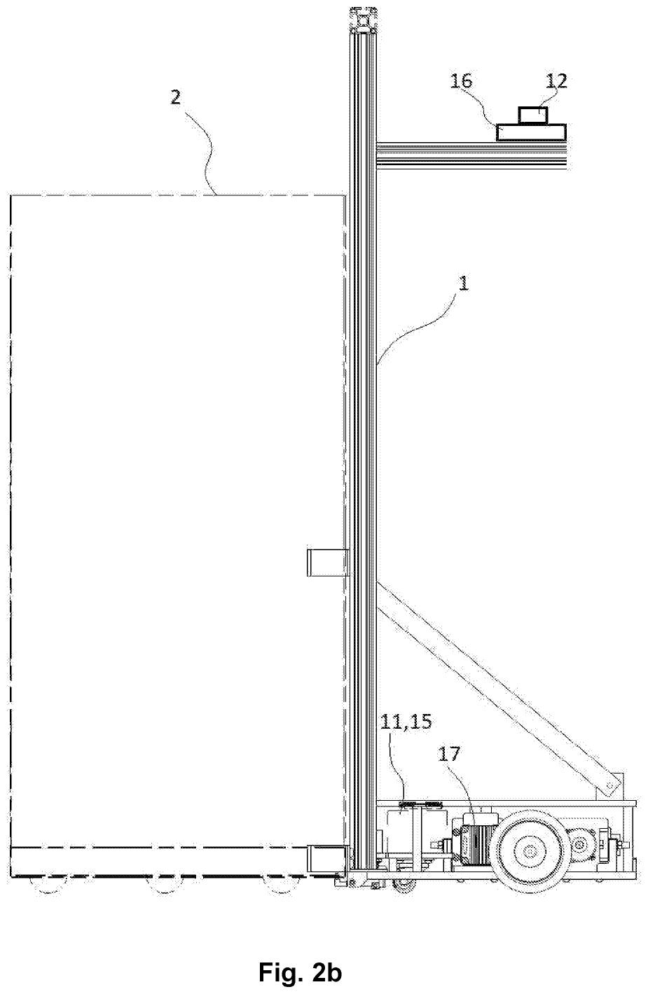

Each transport vehicle 1 is designed to transport exactly one can 2, either full or empty, the can being provided with its own rolling members for movement on the floor of the spinning mill, so that, when being handled, it is pulled or pushed by the transport vehicle and is situated outside the ground plan of a moving means of the transport vehicle 1. The transport vehicle 1 is provided with a catching member for catching and holding the can and, if necessary, also with stops and support members for the transported can 2, as shown in FIG. 2b.

In the spinning mill, a localization system is provided which contains information about the infrastructure of the spinning mill, i.e. the position of the filling station 3 and its two storage devices of cans 2 and the position of the spinning machines 4. The localization system of the spinning mill further comprises a plurality of stationary navigation points/anchors 6 of known position relative to the spinning mill infrastructure, the stationary navigation points/anchors 6 and the control system 5 of the spinning mill being interconnected. The navigation points/anchors and the control system 5 of the spinning mill are wirelessly or cable interconnected to transmit data or to set the power and radio channel of the individual navigation points/anchors 6. In a particular embodiment, the connection is made in the Ultra Wideband standard.

Each spinning machine 4 is provided with a known control system (not shown) connected to the control system 5 of the spinning mill, which usually comprises a control unit for each workstation which is provided with a memory for storing information about the quantity of the sliver deposited in a new can 2 after it has replaced the preceding can and has been placed to a working position at a respective workstation of the spinning machine. The control unit of the workstation of the spinning machine is further provided with means for monitoring the quantity of the processed sliver from the can 2, i.e., for example, the quantity of the spun yarn, and/or for monitoring the distance travelled by the sliver feeding roller or sliver draw-off roller and for generating the information about the quantity of the sliver remaining in the can 2. The information about the quantity of the sliver remaining in the can 2 is passed to the control system 5 of the spinning mill. According to a particular arrangement of the spinning machine, the control unit of the respective workstation, it is the control unit of a machine section or the central control system of the spinning machine that can be used for monitoring the quantity of the sliver remaining in the can 2.

The information about the remaining quantity of the sliver in the can 2 is evaluated in the control system of the spinning machine 4 usually for each natural yarn break by comparing the quantity/weight of the sliver originally deposited in the can 2 to the quantity/weight of the spun yarn and if the difference between these values is within a predetermined interval, a request for can 2 replacement is generated and transmitted to the control system 5 of the spinning mill, which on the basis of this request predicts the moment of the conveying of the can 2 by the transport vehicle 1 to the respective workstation, whereby this request is stored in the request queue which is optimized for the maximum utilization of the spinning machines 4 with regard to the quantity of the sliver in the individual cans 2, current position and utilization of the transport vehicle 1.

If the can 2 is completely or almost completely empty or if the can 2 has been removed by the operator, a priority can 2 replacement request is made in the control system of the spinning machine, which, in the control system 5 of the spinning mill, is placed into the queue of requests for can 2 replacement to a priority position.

The basic part of the transport vehicle 1 is a moving means in which two individually driven drive wheels are arranged, of which the left wheel is coupled to the left motor and the right wheel to the right motor, and both motors are independently connected to the control unit 11 of the transport vehicle 1 and are equipped with rotation sensors 17 which allow the control unit 11 to monitor the speed and number of revolutions and with means for wireless communication with the control system 5 of the spinning mill. The transport vehicle 1 further comprises a transponder 12 for communication with the control system of the spinning mill, with the localization system of the spinning mill and with the control unit 11 of the transport vehicle 1. The transponder 12 is either part of or coupled to the control unit 11 of the transport vehicle 1. On the basis of the radio (wireless) communication between the navigation points/anchors 6 and the transponder 12, the position of the transport vehicle 1 is evaluated by the control system 5 of the spinning mill, based on triangulation. The control unit 11 of the transport vehicle 1 also comprises an inertial sensor 14 consisting of a gyroscope, an accelerometer and a magnetometer, and further comprises a battery management system 15 for monitoring the voltage of the battery cells of the transport vehicle and distance sensors 16 (LIDAR) which serve to monitor the approach to an obstacle, by means of which the control unit 11 creates a virtual approach area Z1 and a virtual near surroundings area Z2 around the vehicle 1. If there is no obstacle in the virtual approach area Z1, the vehicle 1 moves at full speed, which is approximately 2 m/s. If an obstacle appears in the virtual approach area Z1, the speed of the vehicle 1 is reduced, the magnitude of the reduction depending on whether the obstacle is passed in the direction of movement or whether it is in the direction of movement in front of the transport vehicle 1. When passing an obstacle, the speed reduction is smaller. If there is an obstacle in the virtual near surroundings area Z2, the transport vehicle 1 immediately stops. The motor of each of the drive wheels of the transport vehicle 1 is coupled to a current flow meter which is part of or coupled to the control unit 11, and in the event of an unexpected decrease in the magnitude of the current, particularly during acceleration or smooth driving, this fact is evaluated as a slip of the respective wheel, and information about this event is transmitted to the control system 5 of the spinning mill, where it is used to specify the current position of the transport vehicle.

By means of wireless communication of its control unit 11 with the control system 5 of the spinning mill, the transport vehicle 1 shares data on the battery condition, in particular the minimum value of the cell voltage, the current values of the wheel counters and data from the inertial sensor 14 formed by the coordinates X-Y-Z of the gyroscope, X-Y-Z of accelerometers, and X-Y-Z of the magnetometer. For efficient data communication, the data from the sensors is transmitted continuously and battery data on request. Data on approaching to an obstacle and data on critical battery voltage is transmitted immediately at the respective event. Due to the voltage drop of the battery cells, the control unit 11 of the transport vehicle 1 generates a request to the control system 5 of the spinning mill to drive to the charging station.

The control system 5 of the spinning mill can be integrated into the control system of one of the spinning machines 4 and the stationary navigation points/anchors 6 can be located on the frames of the spinning machines 4, whereby a sufficient distance of the navigation points/anchors 6 from the metal parts of the machines must be maintained so as not to affect the parameters of the anchors' antennas 6, which is achieved, for example, by using plastic holders.

Based on the commands from the control system 5 of the spinning mill, the control unit 11 of the transport vehicle 1 controls the rotation of the left-wheel drive motor and the rotation of the right-wheel drive motor by commands to change the orientation by a certain angle and/or commands to travel over a specified distance, thereby guiding the transport vehicle 1 along an optimal path, which has been chosen by the control system 5 of the spinning mill. Reaching the desired position is evaluated by the control system 5 of the spinning mill similarly to the PTP (point-to-point) positioning of industrial robotics. A zone is designated for each point of the intended path and, if the transport vehicle reaches that zone, its position is evaluated as fulfilled. The zones are either circular, for example, when the transport vehicle 1 bypasses an obstacle or arrives at the desired end position, or rectangular, for example, when the transport vehicle 1 passes through an aisle between the machines, where an error in the longitudinal direction is not as critical as in the transverse direction.

Based on the information about the quantity of the sliver remaining in the can 2 by the individual workstations of the spinning machines or on the information about the removal of the can 2 by the operator at a specific workstation of the spinning machine, the spinning machine 4 generates a request for a can 2 exchange at the respective workstation and passes this request to the control system 5 of the spinning mill. On the basis of this request, the spinning system 5 of the spinning mill predicts the moment of conveying the can 2 by the transport vehicle 1 to the respective workstation of the spinning machine 4 and the request with the information about the moment of conveying the can 2 is stored in the memory of the control system 5 of the spinning mill in the queue of requests. The request queue for the replacement of the can 2 is optimized for the maximum utilization of the spinning machines 4 with regard to the current position and working activity of the transport vehicle 2, whereby in order to control the individual transport vehicles (1), data/information from the localization system of the spinning mill as well as data/information from the transport vehicle (1) is evaluated and processed.

The position, direction and speed of the transport vehicle 1 relative to the spinning infrastructure are monitored by mutual communication between the transport vehicle 1 and the stationary anchors 6, the information about them is transmitted to the control system 5 of the spinning mill and on the basis of this information commands are created in the control system 5 of the spinning mill for the transport and other activities of the transport vehicle 1.

### INDUSTRIAL APPLICABILITY

The invention can be used to automate the replacement of cans in spinning mills.

### LIST OF REFERENCES

1 transport vehicle of cans

11 control unit of transport vehicle

12 transponder of transport vehicle

14 inertial sensor

15 battery management system

16 sensor(s) of distance (LIDAR)

17 sensor of motor rotation

Z1 virtual approach area

Z2 virtual near surroundings area

2 can

3 filling station of sliver into cans

4 spinning machine

5 control system of spinning mill

6 anchor

1. A method of controlling a transport vehicle for transporting exactly one sliver can (2) in a spinning mill between a filling station (3) for filling cans (2) with a sliver and can (2) working positions near workstations of spinning machines (4), which ensures that the spinning machines are supplied with full sliver cans (2), characterized in that a request to replace the can (2) at the respective workstation of the spinning machine (4) is made on the basis of information from the spinning machines (4) about the remaining amount of the sliver in the cans (2) near the individual workstations of the spinning machines (4), or on the basis of information about the removal of the can (2) by the operator during spinning, the information being passed to the control system (5) of the spinning mill, which on the basis of this request predicts the moment of the conveying of the can (2) by the transport vehicle (1) to the respective workstation, whereby the request is placed into a request queue which is optimized for the maximum utilization of the spinning machines (4 with respect to the amount of the sliver in the individual cans, the current position and utilization and the loading of the transport vehicles (1).

2-13. (canceled)
